(19) United States
(12) Patent Application Publication
(10) Pub. No.: US 2026/0307734 A1
(43) Pub. Date: Oct. 8, 2026

(54) VEHICLE BODY LOWER STRUCTURE

(71) Applicants: Kia Corporation, Seoul (KR); Hyundai Motor Company, Seoul (KR)

(72) Inventors: Jinyoung Mo, Hwaseong-si (KR); Hyeongwoon Lee, Hwaseong-si (KR); Hae Hoon Lee, Hwaseong-si (KR); Seung Min Jeong, Hwaseong-si (KR)

(21) Appl. No.: 19/573,734

(22) Filed: Mar. 20, 2026

(30) Foreign Application Priority Data
Apr. 2, 2025 (KR) 10-2025-0042555
Sep. 26, 2025 (KR) 10-2025-0139789

(51) Int. Cl. B62D 25/08; B62D 25/20

(52) U.S. Cl. CPC B62D 25/088; B62D 25/2027

(57) ABSTRACT

A vehicle body lower structure of a vehicle body may include a rear cross member disposed in a width direction of the vehicle body at a rear portion of the vehicle body, a rear side member disposed on a side of the rear portion of the vehicle body extending in a longitudinal direction of the vehicle body, and a shock absorber module mount part mounted between the rear cross member and the rear side member, and connecting to the rear cross member and the rear side member. The vehicle body lower structure may include a spring seat connected to a lower portion of the shock absorber module mount part, wherein the spring seat is connected to the rear side member, and wherein a spring mount center position of the spring seat is positioned more inward of the vehicle body than a width direction center position of the rear side member.

### CROSS-REFERENCE TO RELATED APPLICATIONS

This application claims priority to and the benefit of Korean Patent Application No. 10-2025-0042555 filed with the Korean Intellectual Property Office on Apr. 2, 2025, and Korean Patent Application No. 10-2025-0139789 filed with the Korean Intellectual Property Office on Sep. 26, 2025, the entire contents of which are incorporated herein by reference.

### TECHNICAL FIELD

The present disclosure relates to a vehicle body lower structure.

### BACKGROUND

Reflecting the demands of consumers, a low-floor platform for securing a wide interior space is required.

The mounting position and mounting structure of the suspension can be the key to securing the vehicle body interior space and implementing a low-floor platform, and can be a factor that determines the lower strength of the vehicle body.

In addition, as a suppress measure against environmental pollution, the development and use of environment-friendly vehicles are expanding.

Environment-friendly vehicles include, for example, hybrid vehicles, electric battery vehicles, hydrogen electric vehicles, etc., and high-capacity batteries that store electrical energy are applied, so the weight of the vehicle can be relatively increased.

In order to implement a low-floor platform for environment-friendly vehicles, for example, EV vehicles, a more close study on the mounting position and mounting structure of the suspension is required.

The matters described in this background section are prepared to promote understanding of the background of the present disclosure and may include matters that are not conventional art already publicly known, available, or in use.

### SUMMARY

The disclosed example embodiments relate to a vehicle body lower structure, and more particularly, the disclosed example embodiments relate to a vehicle body lower structure capable of expanding a vehicle body interior space.

Some embodiments of the present disclosure may provide a vehicle body lower structure that can implement a low-floor platform to secure a wide interior space and increase the lower strength of the vehicle body.

A vehicle body lower structure according to an embodiment of the present disclosure may include a rear cross member disposed in the width direction of the vehicle body, rear side members respectively provided on both sides of the rear of the vehicle body, and a shock absorber module mount part mounted between the rear cross member and the rear side member.

A vehicle body lower structure according to an embodiment of the present disclosure may further include a wheel house outer panel mounted on a vehicle width direction outer side of the rear side member.

A vehicle body lower structure according to an embodiment of the present disclosure may further include a rear side member upper reinforcing portion connected to an upper portion of the rear side member at a position corresponding to the shock absorber module mount part.

The rear side member and the rear side member upper reinforcing portion may form a vertical direction double cross-section.

A vehicle body lower structure according to an embodiment of the present disclosure may further include a wheel house inner panel connected to the rear cross member and bent upward to be connected to the shock absorber module mount part.

The shock absorber module mount part may include a shock absorber module mounting bracket that connects the rear side member and the wheel house inner panel, and a shock absorber module may be mounted to the shock absorber module mounting bracket.

The shock absorber module mount part may further include a shock absorber module mounting support connected to an upper portion of the shock absorber module mounting bracket to form a shock absorber mount cross-section together with the shock absorber module mounting bracket.

The shock absorber module mount part may further include a mounting bracket reinforcing portion in which a side connection reinforcing portion protruding in an upper direction is formed and which connects the rear side member, the shock absorber module mounting bracket, and the wheel house inner panel.

The shock absorber module mount part may include a front shock absorber module mount part disposed in a front direction of the vehicle body and a rear shock absorber module mount part disposed behind the front shock absorber module mount part.

A vehicle body lower structure according to an embodiment of the present disclosure may further include a spring seat connected to a lower portion of any one of the front shock absorber module mount part or the rear shock absorber module mount part and the rear side member.

A spring mount center position of the spring seat may be positioned more inward of the vehicle body than a width direction center position of the rear side member.

A vehicle body lower structure according to an embodiment of the present disclosure may further include a spring seat mounting reinforcing portion connecting the spring seat and the rear side member.

A vehicle body lower structure according to an embodiment of the present disclosure may further include a side member spring seat reinforcing portion mounted inside the rear side member at an upper portion of the spring seat.

A vehicle body lower structure according to an embodiment of the present disclosure may further include a wheel house inner panel connected to the rear cross member and bent upward to be connected to the front shock absorber module mount part and the rear shock absorber module mount part.

The front shock absorber module mount part and the rear shock absorber module mount part each may include a shock absorber module mounting bracket that connects the rear side member and the wheel house inner panel, and to which a shock absorber module is mounted, and a shock absorber module mounting support connected to an upper portion of the shock absorber module mounting bracket to form a shock absorber mount cross-section together with the shock absorber module mounting bracket.

The front shock absorber module mount part and the rear shock absorber module mount part each may further include a mounting bracket reinforcing portion in which a side connection reinforcing portion protruding in an upper direction is formed and which connects the rear side member, the shock absorber module mounting bracket, and the wheel house inner panel.

The vehicle body lower structure may further include a spring seat upper support connecting the rear side member and the mounting bracket reinforcing portion at an upper portion of the spring seat.

A trailing arm module mount hole to which a trailing arm module is mounted may be formed at a lower portion of the rear side member.

Implementing a vehicle body lower structure according to an embodiment of the present disclosure, a wide interior space can be secured by mounting the shock absorber module between the rear cross member and the rear side member.

Implementing a vehicle body lower structure according to an embodiment of the present disclosure, a low-floor platform can be implemented by mounting the shock absorber module between the rear cross member and the rear side member.

Using a vehicle body lower structure according to an embodiment of the present disclosure, the load transmitted from the shock absorber module can be dispersed into the vehicle body.

Using a vehicle body lower structure according to an embodiment of the present disclosure, the NVH performance of the vehicle can be improved by increasing the vehicle body strength of the part where the shock absorber module is mounted.

Regarding effects and advantages that can be obtained or predicted due to an embodiment of the present disclosure, they may be disclosed directly or implicitly in the detailed description of the example embodiments of the present disclosure. That is, various effects and advantages predicted according to some example embodiments of the present disclosure will be disclosed within the detailed description to be described later.

### BRIEF DESCRIPTION OF THE DRAWINGS

Because the drawings are for reference in explaining the disclosed example embodiments of the present disclosure, technical ideas of the present disclosure are not be interpreted as necessarily limited to the accompanying drawing.

FIG. 1 is a perspective view of a vehicle body to which a vehicle body lower structure according to an example embodiment of the present disclosure may be applied.

FIG. 2 is a bottom view of a vehicle body lower structure according to an example embodiment of the present disclosure.

FIG. 3 is a partial perspective view of a vehicle body lower structure according to an example embodiment of the present disclosure.

FIG. 4 is a partially exploded perspective view in which a rear side member upper reinforcing portion is separated from a vehicle body lower structure according to an example embodiment of the present disclosure.

FIG. 5 is a partially exploded perspective view in which a shock absorber module mounting support is separated from a vehicle body lower structure according to an example embodiment of the present disclosure.

FIG. 6 is a partially exploded perspective view in which a side member spring seat reinforcing portion is separated from a vehicle body lower structure according to an example embodiment of the present disclosure.

FIG. 7 is a partially exploded perspective view in which a mounting bracket reinforcing portion and a spring seat upper support are separated from a vehicle body lower structure according to an example embodiment of the present disclosure.

FIG. 8 is a partially exploded perspective view in which a shock absorber module mounting bracket and a wheel house inner panel are separated from a vehicle body lower structure according to an example embodiment of the present disclosure.

FIG. 9 is a partial perspective view in which a spring seat mounting reinforcing portion is separated from a vehicle body lower structure according to an example embodiment of the present disclosure.

FIG. 10 is a cross-sectional view taken along the line X-X of FIG. 3.

FIG. 11 is a cross-sectional view taken along the line XI-XI of FIG. 3.

The drawings referred to above are not necessarily shown to scale and may be understood as presenting a somewhat simplified representation of various features illustrating some principles of some example embodiments of the present disclosure. For example, specific design features of an embodiment including specific dimensions, direction, position, and shape may be determined in part by the specific intended application and use environment.

### DETAILED DESCRIPTION OF ILLUSTRATIVE EMBODIMENTS

Hereinafter, some example embodiments of the present disclosure will be described in detail with reference to the accompanying drawings so that a person of an ordinary skill in the technical field to which the present disclosure belongs can easily carry it out. However, the disclosed example embodiment of the present disclosure may be implemented in many different forms for other embodiments and the present disclosure is not necessarily limited to the example embodiments described here.

To clearly explain the disclosed example embodiments, parts unrelated to the explanation may be omitted, and like reference numerals may designate like elements throughout the specification.

Because the size and thickness of each configuration shown in the drawing may be arbitrarily shown for better understanding and ease of description, the present disclosure is not necessarily limited to the example embodiments shown in the drawings, and some thicknesses may be enlarged to clearly express various parts and regions.

Terms used herein may be for describing specific example embodiments and are not intended to necessarily limit the present disclosure. As used herein, singular forms may be intended to also include corresponding plural forms, unless the context clearly indicates otherwise.

In the following detailed description, distinguishing the names of the configurations as “first,” “second,” etc., may be to distinguish them when the configurations are in the same relationship, and such parts are not necessarily limited to that order in the following description.

Throughout the specification, when a part is said to include a certain component, it may further include other components rather than necessarily excluding other components, unless there is a special description to the contrary.

When a part such as a layer, film, region, plate, etc., is said to be “on” another part, this may include not only an example for which it is directly above the other part but also an example for which there is another part in between.

In contrast, when an element is referred to as being “directly on” another element, there may be no intervening elements present.

It may be understood that the terms “includes” and/or “including” as used in this specification indicate the presence of specified features, integers, steps, operations, elements and/or components, but do not exclude the presence or addition of one or more other features, integers, steps, operations, components, and/or groups thereof.

As used in this specification, the term “and/or” includes any one or all combinations of one or more associated listed items.

In this specification, the term “coupled” may indicate a physical relationship between two components where the components are directly connected to each other by welding, rivet (Rivet), SPR (Self Piercing Rivet), FDS (Flow Drill Screw), structural adhesive, etc., or indirectly connected through one or more intermediate components, for example.

As used in this specification, “vehicle”, “car”, “vehicle’s”, or other similar terms may include vehicles including passenger vehicles including sports utility vehicles (SUV), buses, tractors, trucks, various commercial vehicles, ships including various types of boats or vessels, aircraft and similar ones, and include hybrid vehicles, electric vehicles, plug-in hybrid electric vehicles, hydrogen fuel vehicles and other alternative fuel (e.g., fuel obtained from resources other than petroleum) vehicles, for example.

In this specification, the reference direction for explaining the following components may be set as the vehicle body longitudinal direction (e.g., vehicle body length direction or longitudinal direction), vehicle width direction (e.g., left-right direction or transverse direction) and vertical direction (e.g., height direction), with the vehicle body as the reference.

Some example embodiments of the present invention will hereinafter be described in detail with reference to the accompanying drawings.

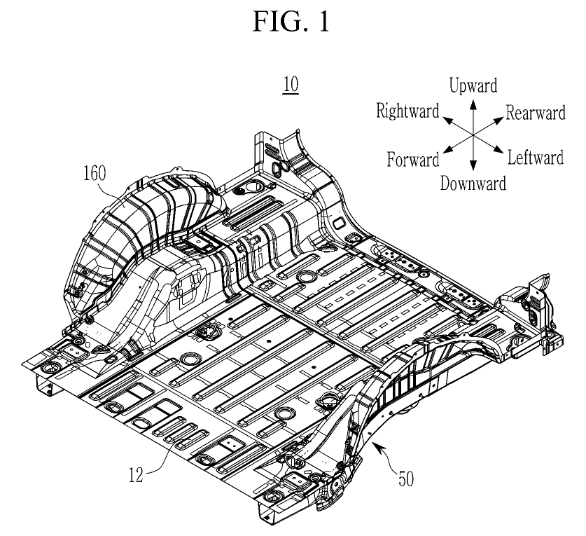

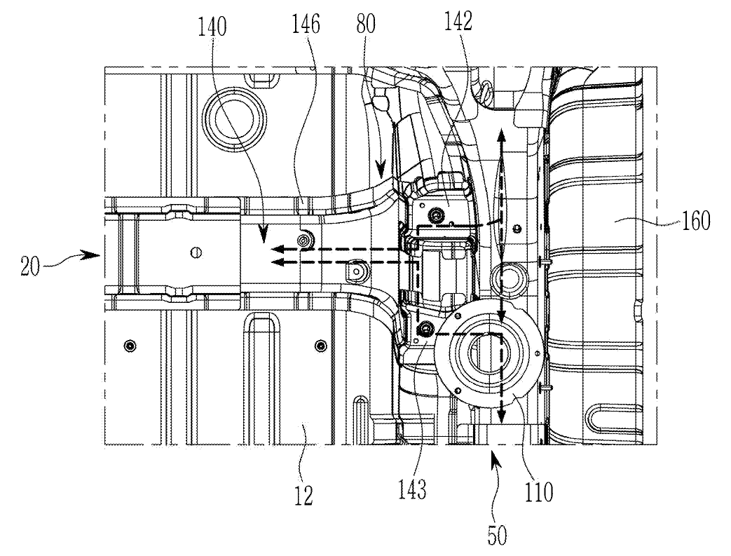

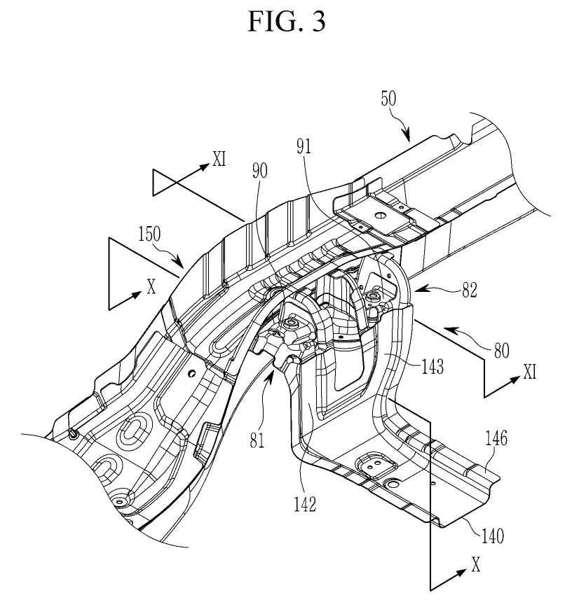

FIG. 1 is a perspective view of a vehicle body to which a vehicle body lower structure according to an example embodiment of the present disclosure may be applied. FIG. 2 is a bottom view of a vehicle body lower structure according to an example embodiment of the present disclosure. FIG. 3 is a partial perspective view of a vehicle body lower structure according to an example embodiment of the present disclosure.

The vehicle body lower structure according to an example embodiment may secure the strength of the part where the rear suspension module, to which the vehicle body load is transmitted, is mounted and to provide a structure capable of expanding the interior space.

Referring to FIGS. 1-3, in some embodiments, the vehicle body lower structure may implement a low-floor platform that may expand the interior space of the vehicle body 10.

The vehicle body lower structure according to an example embodiment may include a rear cross member 20 disposed in the width direction of the vehicle body, rear side members 50 respectively provided on both sides of the rear of the vehicle body, and a shock absorber module mount part 80 mounted between the rear cross member 20 and the rear side member 50.

The vehicle body lower structure according to an example embodiment may further include a wheel house outer panel 160 mounted on the vehicle width direction outer side of the rear side member 50.

That is, in a vehicle body lower structure according to an example embodiment, the rear side member 50 may be mounted in the vehicle inward direction of the wheel house outer panel 160, and the shock absorber module mount part 80 may be formed in the vehicle inward direction of the rear side member 50.

In some embodiments, the mounting position and mount shape of the rear floor panel can be major factors for securing the vehicle interior space.

In the vehicle body lower structure according to an example embodiment, a rear floor panel 12 may be connected to the upper portion of the rear side member 50, and the shock absorber module mount part 80 may be connected in the vehicle inward direction of the rear side member 50, so that the mount space for mounting the shock absorber module mount part 80 may be minimized. Through this, in some embodiments, the height at which the rear floor panel 12 is mounted may be relatively lowered, and even the space adjacent to the rear side member 50 may be utilized as an interior space.

In some embodiments, the shock absorber module mount part 80 may be mounted at the part where the rear side member 50 and the rear cross member 20 are connected, so that the load transmitted from the shock absorber module mount part 80 may be dispersed in the width direction of the vehicle body 10 and in the longitudinal direction of the vehicle body through the rear side member 50 and the rear cross member 20.

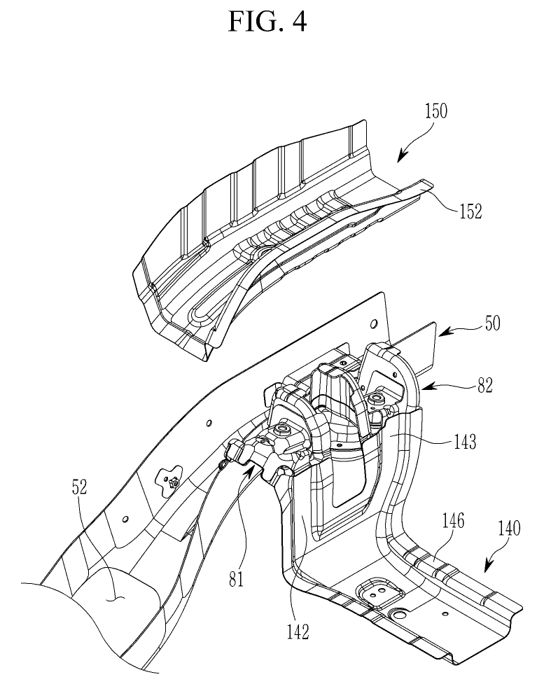

The vehicle body lower structure according to an example embodiment may further include a rear side member upper reinforcing portion 150 connected to the upper portion of the rear side member 50 at a position corresponding to the shock absorber module mount part 80. In some embodiments, the rear side member upper reinforcing portion 150 may include an upper reinforcing portion upper flange 152 (see, e.g., FIG. 4) bent and formed upward, and the rear floor panel 12 may be connected to and supported by the upper reinforcing portion upper flange 152.

The vehicle body lower structure according to an example embodiment may further include a wheel house inner panel 140 connected to the rear cross member 20 and bent upward to be connected to the shock absorber module mount part 80.

In some embodiments, the wheel house inner panel 140 may include a bent wheel house inner panel flange 146, and the wheel house inner panel flange 146 may be connected to the rear floor panel 12 to support the rear floor panel 12.

In some embodiments, the load of the shock absorber module mount part 80 may be dispersed through the rear cross member 20 and the rear floor panel 12 through the wheel house inner panel 140, as illustrated in FIG. 2.

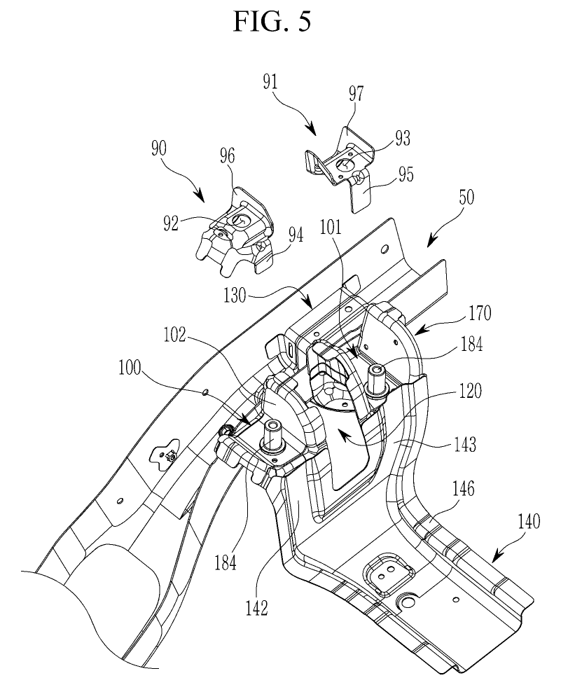

FIG. 4 is a partially exploded perspective view in which a rear side member upper reinforcing portion is separated from a vehicle body lower structure according to an example embodiment of the present disclosure. FIG. 5 is a partially exploded perspective view in which a shock absorber module mounting support is separated from a vehicle body lower structure according to an example embodiment of the present disclosure.

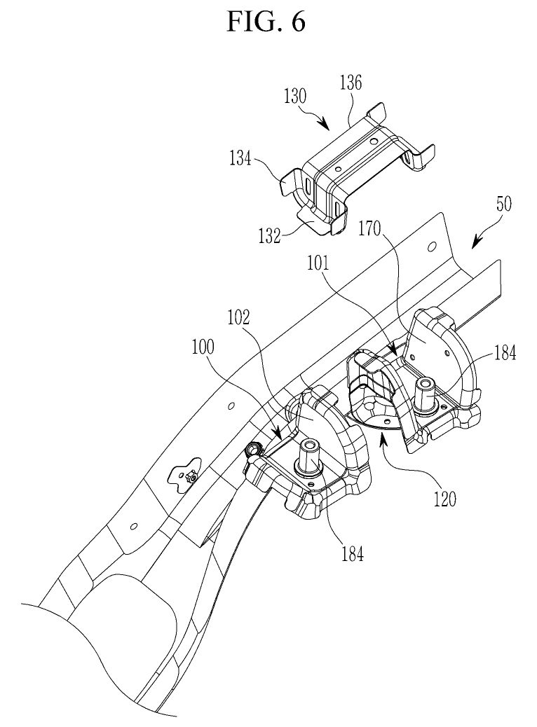

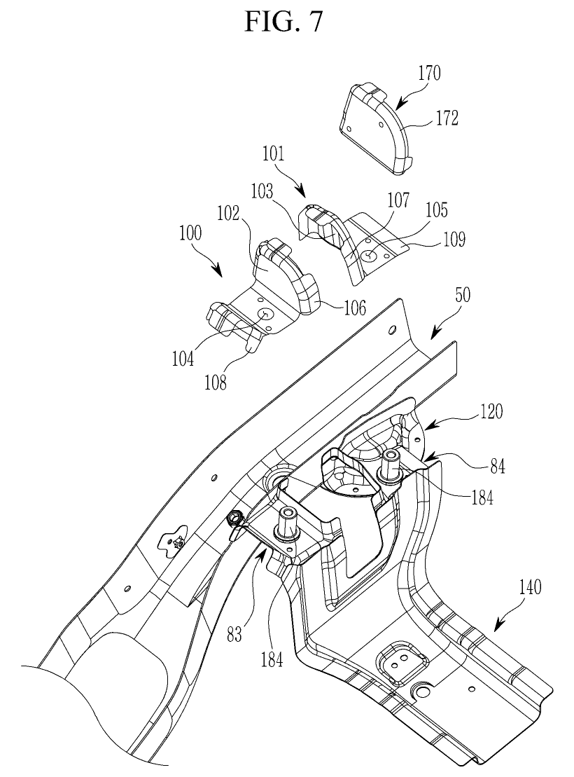

FIG. 6 is a partially exploded perspective view in which a side member spring seat reinforcing portion is separated from a vehicle body lower structure according to an example embodiment of the present disclosure. FIG. 7 is a partially exploded perspective view in which a mounting bracket reinforcing portion and a spring seat upper support are separated from a vehicle body lower structure according to an example embodiment of the present disclosure.

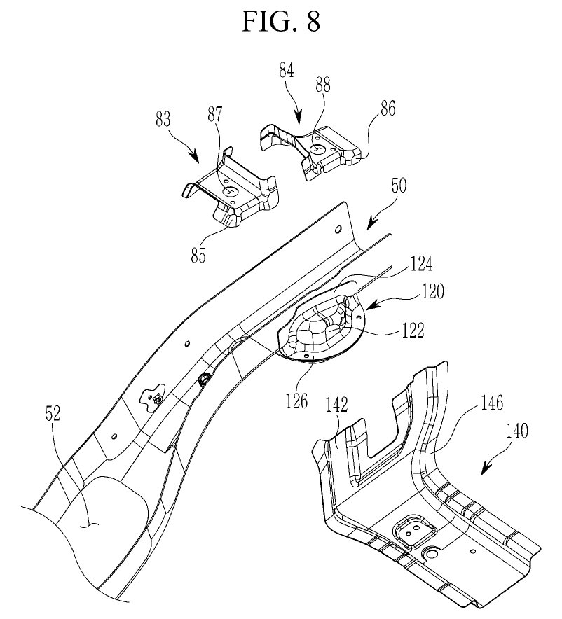

FIG. 8 is a partially exploded perspective view in which a shock absorber module mounting bracket and a wheel house inner panel are separated from a vehicle body lower structure according to an example embodiment of the present disclosure.

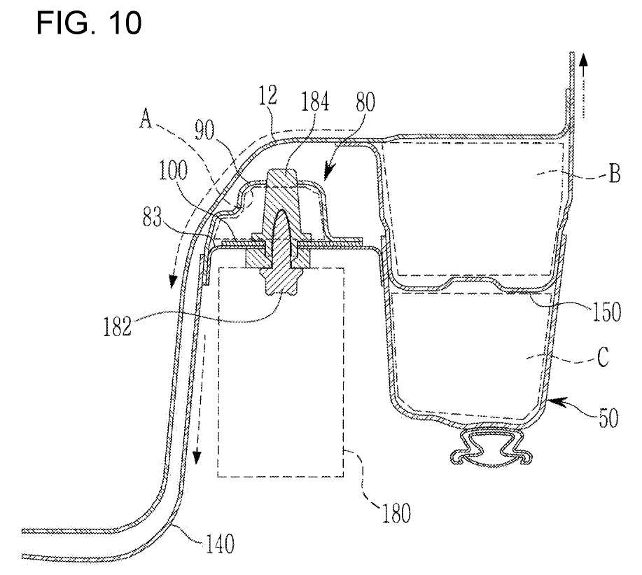

Referring to FIGS. 1-8, in some embodiments, the shock absorber module mount part 80 may include shock absorber module mounting brackets 83 and 84 that connect the rear side member 50 and the wheel house inner panel 140 and to which a shock absorber module 180 (see, e.g., FIG. 10) may be mounted.

In some embodiments, the shock absorber module mount part 80 may include a front shock absorber module mount part 81 disposed in a front direction of the vehicle body, and a rear shock absorber module mount part 82 disposed behind the front shock absorber module mount part 81. In some embodiments, to support the shock absorber module 180 and disperse the load transmitted from the shock absorber module 180 to the vehicle body, the shock absorber module mount part 80 may include the front shock absorber module mount part 81 and the rear shock absorber module mount part 82.

In the drawings, it is illustrated that in some embodiments, two shock absorber module mount parts 80 may be provided as the front shock absorber module mount part 81 and the rear shock absorber module mount part 82, but the present disclosure is not necessarily limited thereto, and for some embodiments it is also possible that one or three or more are provided. For convenience of understanding, some example embodiments of the present disclosure illustrate two shock absorber module mount parts 80 provided as the front shock absorber module mount part 81 and the rear shock absorber module mount part 82.

In some embodiments, the front shock absorber module mount part 81 and the rear shock absorber module mount part 82 may each include the shock absorber module mounting brackets 83 and 84.

In some embodiments, the wheel house inner panel 140 may include wheel house inner panel legs 142 and 143 connected to the front shock absorber module mount part 81 and the rear shock absorber module mount part 82, respectively.

In some embodiments, the shock absorber module mounting brackets 83 and 84 may each include bent module mounting bracket flanges 85 and 86 (see, e.g., FIG. 8), and the module mounting bracket flanges 85 and 86 may be connected to the inner side surface of the rear side member 50 and the wheel house inner panel legs 142 and 143 of the wheel house inner panel 140.

In some embodiments, the load of the shock absorber module 180 transmitted from the front shock absorber module mount part 81 and the rear shock absorber module mount part 82 may be dispersed through the rear cross member 20 and the rear floor panel 12 through the wheel house inner panel legs 142 and 143.

In some embodiments, the wheel house inner panel legs 142 and 143 may have a pincer or “Y” shape and may disperse the load transmitted from the front shock absorber module mount part 81 and the rear shock absorber module mount part 82 through the rear cross member 20 and the rear floor panel 12.

In some embodiments, module mounting bracket coupling holes 87 and 88 may be formed in the front shock absorber module mount part 81 and the rear shock absorber module mount part 82, respectively, (see, e.g., FIG. 8). In some embodiments, a fastening device, such as a shock absorber module coupling bolt 182 and a shock absorber module coupling nut 184 (see, e.g., FIG. 10) may be inserted into the module mounting bracket coupling holes 87 and 88 so that the shock absorber module 180 may be mounted.

In some embodiments, the shock absorber module mount part 80 may further include shock absorber module mounting supports 90 and 91 connected to the upper portion of the shock absorber module mounting brackets 83 and 84. In some embodiments, the shock absorber module mounting supports 90 and 91 may mount the shock absorber module 180 together with the shock absorber module mounting brackets 83 and 84.

For example, in some embodiments, module mounting support coupling holes 92 and 93 may be formed in the shock absorber module mounting supports 90 and 91, and a fastening device, such as the shock absorber module coupling bolt 182 and the shock absorber module coupling nut 184, may be inserted into the module mounting support coupling holes 92 and 93 so that the shock absorber module 180 may be mounted.

In some embodiments, the shock absorber module mount part 80 may further include mounting bracket reinforcing portions 100 and 101.

For some embodiments, in the mounting bracket reinforcing portions 100 and 101, side connection reinforcing portions 102 and 103 may be protruding in an upper direction, and the side connection reinforcing portions 102 and 103 may connect the rear side member 50, the shock absorber module mounting brackets 83 and 84, and the wheel house inner panel 140.

For example, in some embodiments, the mounting bracket reinforcing portions 100 and 101 may be disposed between the shock absorber module mounting brackets 83 and 84 and the shock absorber module mounting supports 90 and 91 to strengthen the connectivity between the rear side member 50 and the shock absorber module mount part 80, and to increase the strength of the shock absorber module mount part 80.

In some embodiments, bent mounting bracket reinforcing portion side flanges 106 and 107 may be formed in the side connection reinforcing portions 102 and 103, and the bent mounting bracket reinforcing portion side flanges 106 and 107 may reinforce the strength of the mounting bracket reinforcing portions 100 and 101 and may be connected to and support the rear floor panel 12.

In some embodiments, the mounting bracket reinforcing portions 100 and 101 may include mounting bracket reinforcing portion lower flanges 108 and 109 bent and formed at the lower portions thereof, and the mounting bracket reinforcing portion lower flanges 108 and 109 may be connected to the shock absorber module mounting brackets 83 and 84.

In some embodiments, mounting bracket reinforcing portion coupling holes 104 and 105 may be formed in the mounting bracket reinforcing portions 100 and 101, and a fastening device, such as the shock absorber module coupling bolt 182 and the shock absorber module coupling nut 184 may be inserted into the mounting bracket reinforcing portion coupling holes 104 and 105 so that the shock absorber module 180 may be mounted.

In some embodiments, module mounting support lower flanges 94 and 95 may be formed at the lower portions of the shock absorber module mounting supports 90 and 91 (see, e.g., FIG. 5), and the module mounting support lower flanges 94 and 95 may be connected to the mounting bracket reinforcing portions 100 and 101. In some embodiments, module mounting support side flanges 96 and 97 may be formed at the side portions of the shock absorber module mounting supports 90 and 91, and the module mounting support side flanges 96 and 97 may be connected to the side connection reinforcing portions 102 and 103.

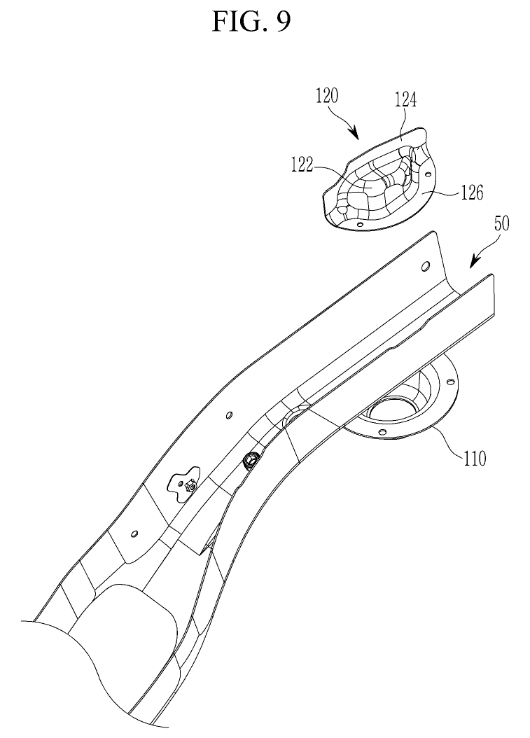

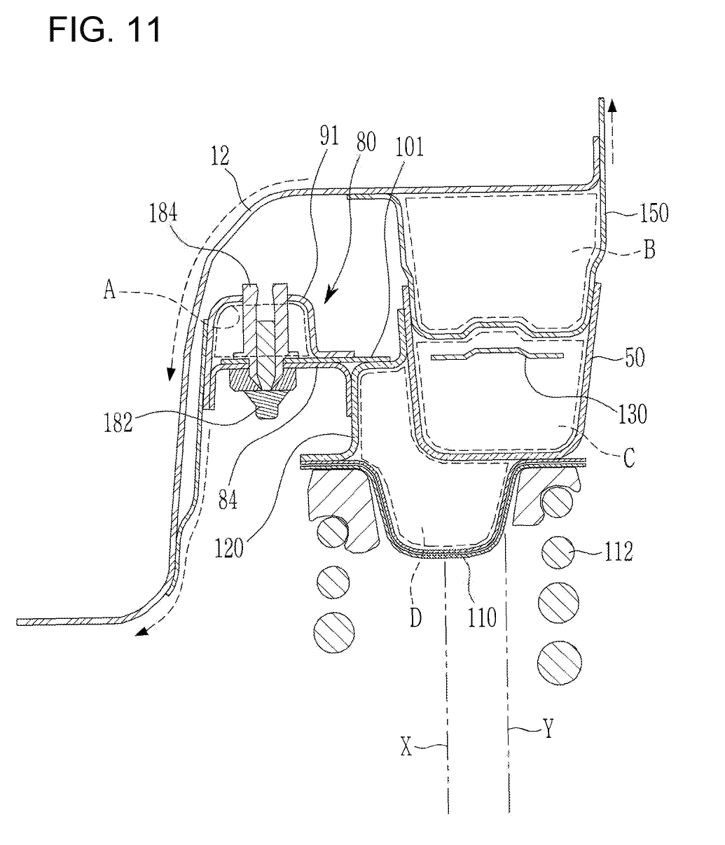

FIG. 9 is a partial perspective view in which a spring seat mounting reinforcing portion is separated from a vehicle body lower structure according to an example embodiment of the present disclosure. FIG. 10 is a cross-sectional view taken along the line X-X of FIG. 3. FIG. 11 is a cross-sectional view taken along the line XI-XI of FIG. 3.

Referring to FIGS. 3, 9, and 11, in some embodiments, a vehicle body lower structure may further include a spring seat 110 connected to the lower portion of any one of the front shock absorber module mount part 81 or the rear shock absorber module mount part 82 and the rear side member 50. In the drawings, some example embodiments illustrate that the spring seat 110 may be mounted to the lower portion of the rear shock absorber module mount part 82, but the present disclosure is not necessarily limited thereto, and in some embodiments, the spring seat 110 may be mounted to the lower portion of the front shock absorber module mount part 81.

Referring to FIG. 11, in some embodiments, the spring mount center position X of the spring seat 110 may be positioned more inward of the vehicle body than the width direction center position Y of the rear side member 50.

In some embodiments, the vehicle body lower structure may further include a spring seat mounting reinforcing portion 120 connecting the spring seat 110 and the rear side member 50.

In some embodiments, a spring 112 of the rear suspension module may be provided at the lower portion of the spring seat 110 so that the load transmitted from the rear suspension module may be dispersed through the spring seat 110, the spring seat mounting reinforcing portion 120, the rear side member 50, the wheel house inner panel 140, the rear cross member 20, and the rear floor panel 12.

In some embodiments, the road load transmitted from the road surface may be partially absorbed by the spring 112, and appropriately dispersed in the longitudinal direction and in the width direction of the vehicle body through the spring seat 110 and the spring seat mounting reinforcing portion 120, so that the noise, vibration, and harshness (NVH) characteristic of the vehicle may be improved.

In some embodiments, even if the spring mount center position X of the spring seat 110 is positioned more inward of the vehicle body than the width direction center position Y of the rear side member 50 and the shock absorber module mount part 80 is positioned inside the rear side member 50, the width direction mounting positions of the shock absorber module mount part 80 and the spring seat 110 may be adjacent, so that the suspension characteristic may be improved.

In some embodiments, the spring mount center position X of the spring seat 110 may be positioned more inward of the vehicle body than the width direction center position Y of the rear side member 50, so that mount space utilization of the suspension module may be improved.

In some embodiments, as illustrated in FIGS. 8 and 9, the spring seat mounting reinforcing portion 120 may include a spring seat reinforcing portion body 122 formed protruding upward. In some embodiments, the spring seat 110 may protrude downward to stably support the spring 112, and the spring seat mounting reinforcing portion 120 may protrude upward to form a closed space D together with the spring seat 110, as illustrated in FIG. 11.

In some embodiments, as illustrated in FIGS. 8 and 9, the spring seat mounting reinforcing portion 120 may include a spring seat reinforcing portion side flange 124 bent and formed at a side portion of the spring seat mounting reinforcing portion 120, and the spring seat reinforcing portion side flange 124 may be connected to the side surface of the rear side member 50.

In some embodiments, the spring seat mounting reinforcing portion 120 may include a spring seat reinforcing portion lower flange 126 bent and formed at a lower portion of the spring seat mounting reinforcing portion 120, and the spring seat reinforcing portion lower flange 126 may be connected to the spring seat 110.

In some embodiments, as illustrated in FIGS. 5 and 6, the vehicle body lower structure may further include a side member spring seat reinforcing portion 130 mounted inside the rear side member 50 at the upper portion of the spring seat 110.

Referring to FIGS. 5 and 6, in some embodiments, the side member spring seat reinforcing portion 130 may be positioned at the upper portion of the spring seat 110, and may be mounted inside the rear side member 50 to disperse the road load transmitted from the spring seat 110 through the rear side member 50.

In some embodiments, the side member spring seat reinforcing portion 130 may include a side member spring seat reinforcing portion body 136, and a side member reinforcing portion lower flange 132 and a side member reinforcing portion side flange 134 bent and formed in the side member spring seat reinforcing portion body 136. The side member reinforcing portion lower flange 132 and the side member reinforcing portion side flange 134 may be connected to the lower surface and the side surface of the rear side member 50, respectively, to disperse the road load transmitted from the spring seat 110 through the rear side member 50. In some embodiments, the side member spring seat reinforcing portion 130 may increase the vehicle body longitudinal direction strength of the rear side member 50.

Referring to FIGS. 6 and 7, in some embodiments, the vehicle body lower structure may further include a spring seat upper support 170 connecting the rear side member 50 and the mounting bracket reinforcing portion 101 at the upper portion of the spring seat 110.

In some embodiments, the spring seat upper support 170 may be connected to the upper portion of the mounting bracket reinforcing portions 100 and 101, for example, the mounting bracket reinforcing portion 101 disposed at the rear, to support the upper portion of the spring seat 110, and may disperse the load transmitted from the spring seat 110.

In some embodiments, the spring seat upper support 170 may include a spring seat upper support flange 172 bent and formed upward, and the spring seat upper support flange 172 may be connected to the rear floor panel 12 to support the rear floor panel 12.

Referring to FIG. 4, in some embodiments, a trailing arm module mount hole 52, in which a trailing arm module may be mounted, may be formed at the lower portion of the rear side member 50.

For example, in some embodiments, a trailing arm module mount hole 52 for mounting a part for mounting a trailing arm, such as a trailing arm module, may be formed. In some embodiments, because the trailing arm module may be mounted inside the rear side member 50, the mount space where the suspension system is mounted may be compactly configured, and the mounting position of the rear floor panel 12 connected to the upper portion of the rear side member 50 may be configured adjacent to the rear side member 50. Through this, in some embodiments, it is possible to implement a low-floor platform of a vehicle in which the vehicle interior space is expanded.

Referring to FIG. 10, in some embodiments, the shock absorber module mounting brackets 83 and 84 and the shock absorber module mounting supports 90 and 91 may form a shock absorber mount cross-section A.

In the shock absorber mount cross-section A formed by the shock absorber module mounting brackets 83 and 84 and the shock absorber module mounting supports 90 and 91, the cross-section coefficient may be increased, so that the strength of the part where the shock absorber module 180 is mounted may be increased in some embodiments.

In some embodiments, the rear side member 50 and the rear side member upper reinforcing portion 150 may form a rear side member main cross-section C, as illustrated in FIGS. 10 and 11. In some embodiments, the rear side member upper reinforcing portion 150 may form an upper reinforcing cross-section B together with the rear side member 50 and the rear floor panel 12, as illustrated in FIGS. 10 and 11.

Accordingly in some embodiments, the rear side member 50 and the rear side member upper reinforcing portion 150 may form a vertical direction double cross-section, and the rear side member 50 and the rear side member upper reinforcing portion 150 forming such a double box structure may increase the strength of the rear side member 50.

The double box structure formed by the rear side member 50 and the rear side member upper reinforcing portion 150 may support the shock absorber mount cross-section A, and the shock absorber mount cross-section A may be formed relatively high, so that the operation space, that is, the bump space, of the shock absorber module 180 may be secured in some embodiments.

In some embodiments, the shock absorber mount cross-section A, the rear side member main cross-section C, and the upper reinforcing cross-section B may disperse the load transmitted from the shock absorber module 180 through the rear side member 50, the wheel house inner panel 140, the rear floor panel 12, and the rear cross member 20.

Referring to FIG. 11, in some embodiments, the closed space D formed by the spring seat mounting reinforcing portion 120 and the spring seat 110 together may receive the load transmitted from the spring 112 and disperse it through the rear side member main cross-section C, the upper reinforcing cross-section B, and the shock absorber mount cross-section A.

In some embodiments, the spring mount center position X of the spring seat 110 may be positioned more inward of the vehicle body than the width direction center position Y of the rear side member 50, so that the load transmitted from the spring 112 may be dispersed through the rear side member 50, the wheel house inner panel 140, the rear floor panel 12, and the rear cross member 20. Even if the spring mount center position X of the spring seat 110 is eccentric with respect to the width direction center position Y of the rear side member 50 and the width direction mounting position of the shock absorber module 180, the closed space D, the rear side member main cross-section C, the upper reinforcing cross-section B, and the shock absorber mount cross-section A may be connected, so that the strength against torsion may be maintained in some embodiments.

By implementing a vehicle body lower structure according to some embodiments of the present disclosure, a wide interior space may be secured by mounting the shock absorber module between the rear cross member and the rear side member.

By implementing a vehicle body lower structure according to some embodiments of the present disclosure, a low-floor platform may be implemented by mounting the shock absorber module between the rear cross member and the rear side member.

Implementing a vehicle body lower structure according to some embodiments of the present disclosure, the rear floor may be configured to be flat or more flat, so that the actually usable vehicle interior space may be expanded.

Using a vehicle body lower structure according to some embodiments of the present disclosure, the load transmitted from the shock absorber module may be dispersed into the vehicle body.

Using a vehicle body lower structure according to some embodiments of the present disclosure, the NVH performance of the vehicle may be improved by increasing the vehicle body strength of the part where the shock absorber module is mounted.

Some example embodiments has been described above, but the present disclosure is not necessarily limited to the example embodiments, and other embodiments of the present disclosure may include various changes, such as those recognized as equivalent by a person of an ordinary skill in the technical field to which the present disclosure belongs, in accordance with the claims and equivalents thereof.

What is claimed is:

1. A vehicle body lower structure of a vehicle body, the vehicle body lower structure comprising:
a rear cross member disposed in a width direction of the vehicle body at a rear portion of the vehicle body;
a rear side member disposed on a side of the rear portion of the vehicle body and extending in a longitudinal direction of the vehicle body; and
a shock absorber module mount part mounted between the rear cross member and the rear side member, and connecting to the rear cross member and the rear side member.

2. The vehicle body lower structure of claim 1, further comprising a wheel house outer panel mounted on a vehicle width direction outer side of the rear side member.

3. The vehicle body lower structure of claim 1, further comprising a rear side member upper reinforcing portion connected to an upper portion of the rear side member at a position corresponding to the shock absorber module mount part.

4. The vehicle body lower structure of claim 3, wherein the rear side member and the rear side member upper reinforcing portion are included in a vertical direction double closed cross-section structure.

5. The vehicle body lower structure of claim 1, further comprising a wheel house inner panel connected to the rear cross member and bent upward to be connected to the shock absorber module mount part, wherein the shock absorber module mount part is connected to the rear cross member via the wheel house inner panel.

6. The vehicle body lower structure of claim 5, wherein the shock absorber module mount part comprises a shock absorber module mounting bracket that connects the rear side member and the wheel house inner panel, and wherein the shock absorber module mounting bracket is configured for mounting a shock absorber module.

7. The vehicle body lower structure of claim 6, wherein the shock absorber module mount part further comprises a shock absorber module mounting support connected to an upper portion of the shock absorber module mounting bracket, and wherein a shock absorber mount closed cross-section structure includes the shock absorber module mounting support together with the shock absorber module mounting bracket.

8. The vehicle body lower structure of claim 6, wherein the shock absorber module mount part further comprises a mounting bracket reinforcing portion including a side connection reinforcing portion protruding in an upper direction, and wherein the mounting bracket reinforcing portion connects to the rear side member, the shock absorber module mounting bracket, and the wheel house inner panel.

9. The vehicle body lower structure of claim 1, wherein the shock absorber module mount part is in plural and comprises:
a front shock absorber module mount part disposed in a front direction of the vehicle body; and
a rear shock absorber module mount part disposed behind the front shock absorber module mount part.

10. The vehicle body lower structure of claim 9, further comprising a spring seat connected to a lower portion of the front shock absorber module mount part or the rear shock absorber module mount part, and wherein the spring seat is connected to the rear side member.

11. The vehicle body lower structure of claim 10, wherein a spring mount center position of the spring seat is positioned more inward of the vehicle body than a width direction center position of the rear side member.

12. The vehicle body lower structure of claim 10, further comprising a spring seat mounting reinforcing portion connecting the spring seat and the rear side member.

13. The vehicle body lower structure of claim 10, further comprising a side member spring seat reinforcing portion mounted inside the rear side member at an upper portion of the spring seat.

14. The vehicle body lower structure of claim 10, further comprising a wheel house inner panel connected to the rear cross member and bent upward to be connected to the front shock absorber module mount part and the rear shock absorber module mount part, wherein the front shock absorber module mount part and the rear shock absorber module mount part are connected to the rear cross member via the wheel house inner panel.

15. The vehicle body lower structure of claim 14, wherein the front shock absorber module mount part and the rear shock absorber module mount part each comprise:
a shock absorber module mounting bracket that connects the rear side member and the wheel house inner panel, and wherein the shock absorber module mounting bracket is configured for mounting a shock absorber module; and
a shock absorber module mounting support connected to an upper portion of the shock absorber module mounting bracket, and wherein a shock absorber mount closed cross-section structure includes the shock absorber module mounting support together with the shock absorber module mounting bracket.

16. The vehicle body lower structure of claim 15, wherein the front shock absorber module mount part and the rear shock absorber module mount part each further comprise:
a mounting bracket reinforcing portion including a side connection reinforcing portion protruding in an upper direction, and wherein the mounting bracket reinforcing portion connects to the rear side member, the shock absorber module mounting bracket, and the wheel house inner panel.

17. The vehicle body lower structure of claim 16, further comprising a spring seat upper support connecting the rear side member and the mounting bracket reinforcing portion at an upper portion of the spring seat.

18. The vehicle body lower structure of claim 1, wherein the rear side member includes a trailing arm module mount hole configured to mount a trailing arm module at a lower portion of the rear side member.

19. A vehicle body lower structure of a vehicle body, comprising:
a rear cross member disposed in a width direction of the vehicle body at a rear portion of the vehicle body;
a rear side member disposed on a side of the rear portion of the vehicle body and extending in a longitudinal direction of the vehicle body;
a shock absorber module mount part mounted between the rear cross member and the rear side member, and connecting to the rear cross member and the rear side member;
a wheel house outer panel mounted on a vehicle width direction outer side of the rear side member; and
a spring seat connected to a lower portion of the shock absorber module mount part, wherein the spring seat is connected to the rear side member, wherein a spring mount center position of the spring seat is positioned more inward of the vehicle body than a width direction center position of the rear side member, and wherein the spring seat is more inward than the wheel house outer panel.

20. A vehicle including a vehicle body lower structure comprising:
a rear floor panel;
a rear cross member disposed in a width direction of the vehicle at a rear portion of the vehicle below the rear floor panel and coupled to a bottom side of the rear floor panel;
a rear side member disposed on a side of the rear portion of the vehicle and extending in a longitudinal direction of the vehicle below the rear floor panel and coupled to the bottom side of the rear floor panel;
a shock absorber module mount part mounted between the rear cross member and the rear side member, wherein the shock absorber module mount part is coupled to the rear cross member and the rear side member, wherein the shock absorber module mount part is below the rear floor panel, and wherein the shock absorber module mount part is coupled to the bottom side of the rear floor panel;
a wheel house outer panel mounted on a vehicle width direction outer side of the rear side member and adjacent the rear floor panel; and
a spring seat connected to a lower portion of the shock absorber module mount part, wherein the spring seat is connected to a bottom side of the rear side member, wherein a spring mount center position of the spring seat is positioned more inward of the vehicle than a width direction center position of the rear side member, wherein the spring seat is more inward of the vehicle than the wheel house outer panel, wherein the spring seat is below the rear floor panel, and wherein the spring seat is lower than the wheel house outer panel.
